(19) United States
(12) Patent Application Publication
(10) Pub. No.: US 2003/0049021 A1
(43) Pub. Date: Mar. 13, 2003

(54) Apparatus for monitoring of DVD/CD usage and targeted DVD/CD sales utilizing a set top with DVD/CD capability

(75) Inventor: John Kamieniecki, Lafayette Hill, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(73) Assignee: General Instrument Corporation, Horsham, PA

(21) Appl. No.: 09/951,053

(22) Filed: Sep. 12, 2001

(51) Int. Cl. H04N 5/781; H04N 5/85

(52) U.S. Cl. 386/125; 386/83

(57) ABSTRACT

A subscriber is provided with a combination set-top and DVD/CD player. When the subscriber loads and plays a DVD/CD player, the set top obtains and stores data relating to the DVD/CD being played. This data, accumulated over time, creates a subscriber profile. A head-end periodically acquires the stored profile data, compares it with a large DVD/CD data base to develop a list of DVDs/CDs whose genre/artists are related to the profile. This list is transmitted to the subscriber's set-top to provide suggested titles/artists to the subscriber for possible purchase. Purchase data of the user are employed to create and store a purchase profile at the head-end. The ordered DVDs/CDs are sent by mail and are billed together with an invoice for other cable services The set-top may be provided with a decrypter and writeable DVD/CD drive to receive and record encrypted premium content from the head-end, avoiding the need to ship DVDs/CDs and the attendant costs.

### FIELD OF THE INVENTION

The present invention relates to cable systems employing DVD/CD players and cable set tops and more particularly to a method for monitoring usage of the DVD/CD player for developing a database for a subscriber's selections and providing marketing and sales information.

On-line music players, especially in “MP3” have the ability to “suggest new music titles to a subscriber by observing the subscriber's musical preferences. However, as of the present time, these or similar capabilities are not available on cable systems.

### SUMMARY

It is therefore an object of the present invention to provide the capability of recording DVD and CD titles on a pay basis (i.e. customer is buying a DVD/CD) and to provide this information to a cable head end for developing a subscriber profile, recommending and selling other titles to the subscriber in accordance with the subscriber's preferences and utilizing the subscriber's profile for targeted marketing.

The present invention, in one preferred embodiment thereof, utilizes a Modified Set Top (MST) which is an integrated set top combined with a DVD/CD player and an A/V receiver. The MST has a suitable non-volatile memory for recording title, CD-DVD number and any other identifying information for DVDs and/or CDs inserted into the DVD/CD ROM drive of the integrated DVD/CD player. The list of titles and related data grows with continued use of the DVD/CD player. The information is periodically transferred to the cable set top and is collected from the set top by a controller in the head end employing standard two-way (RF or Telco, i.e. RF or Telephone Company) polling methods. The data maybe aggregated by the MSO (Multi-System Operator) to create a profile/usage data of the subscriber that can be marketed or otherwise made available to one or more marketing groups.

The subscriber's profile developed over time is utilized to target the subscriber with specific music/video “suggestions” of other titles in the same genre and thus creates a capability to target interested consumers to the availability of relevant new releases and thus increase DVD/CD sales, which targeted information can be delivered to the set top using either the in-band downstream path or the OOB (out-of-band) data path.

A subscriber may shop/purchase DVD/CD titles via the set top and the two-way cable plant. Purchase requests can be collected by the head end (again, using polling methods). Purchase data can be added to the viewer database to build purchase profiles and is passed to the billing system as well as a CD/DVD supplier for processing. The purchase items are then shipped to the subscriber's residence.

Alternatively, encrypted premium video and audio content may be delivered from the cable head end to the set top which decrypts and burns the content onto CD or DVD blanks, as well as providing for printing of graphics and/or liner notes which typically accompany a DVD/CD purchased through conventional outlets such as music/video stores and the like, providing the means for the subscriber to purchase CD/DVD titles in the convenience and privacy of his or her home residence, thus avoiding a trip to a store or delivery through the mail or other common carriers as well as the delivery time and costs which would otherwise be experienced.

### BRIEF DESCRIPTION OF THE DRAWINGS

The above as well as other objects of the present invention will become apparent with the accompanying description and drawings in which:

FIG. 1 is a simplified block diagram useful in explaining the unique method and apparatus of the present invention.

FIG. 1a is a more detailed block diagram of the device of FIG. 1.

FIG. 2 is a block diagram showing the cable system incorporating an MST capable of performing the monitoring/targeted sales method of the present invention.

FIG. 3 is a block diagram showing a system substantially the same as that shown in FIG. 2 wherein the DVD/CD supplier is replaced with a DVD/CD content server and an encryption server.

### DETAILED DESCRIPTION OF THE INVENTION AND THE PREFERRED EMBODIMENTS THEREOF

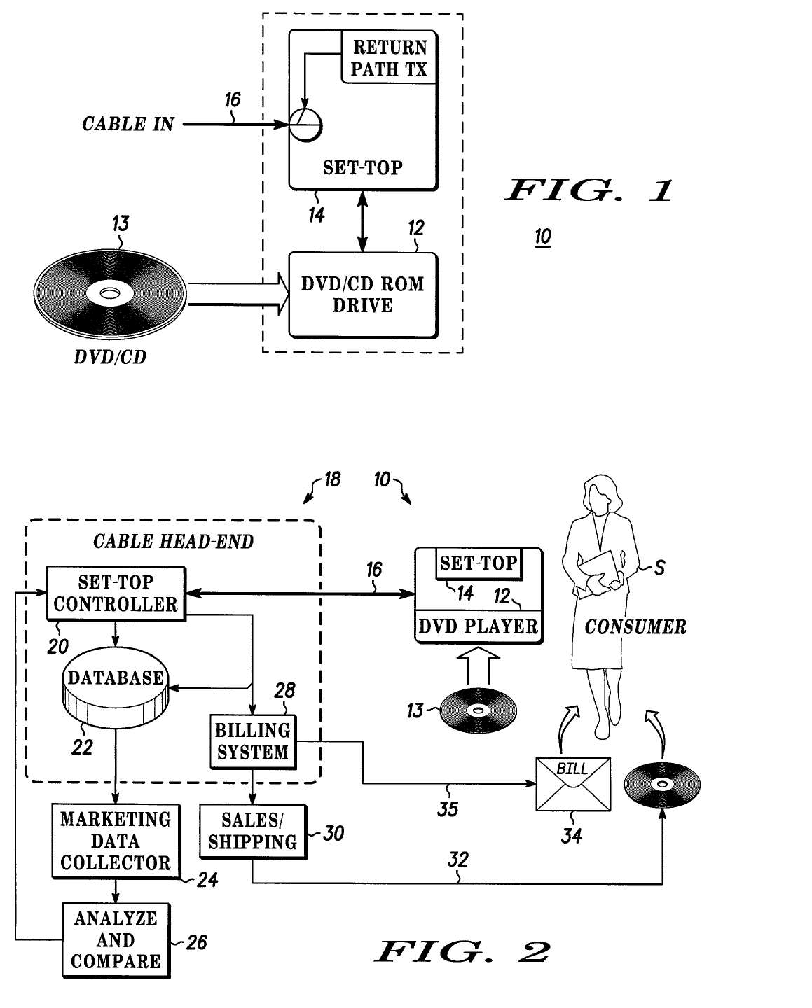

FIG. 1 shows a an MST 10 comprising a DVD/CD ROM drive 12 receiving a DVD/CD. Although not shown, it should be understood that a monitor and speakers are provided for audio visual (AV) presentation of the contents of the DVD/CD. The MST is comprised of a DVD/CD ROM drive 12 and a set top 14 which may, for example, be a model DCT 2000 set top. However, any other suitable set top having similar functional capabilities may be utilized.

Although not shown, for purposes of simplicity, MST 10 is further provided with an audio visual (A/V) receiver for presentation of the audio visual content of the DVD/CD 13 being played.

As is conventional, set top 14 is coupled to the cable system through a cable in-line 16.

The MST 10 has a suitable non-volatile memory a ROM, RAM or FLASH memory, for example, that records information such as library identification numbers (such as CDDB) number and any other identifying information obtained from each DVD and CD that is inserted into the integrated DVD/CD player 12 within MST 10. This data is accumulated over time and grows with continued use of the DVD/CD player.

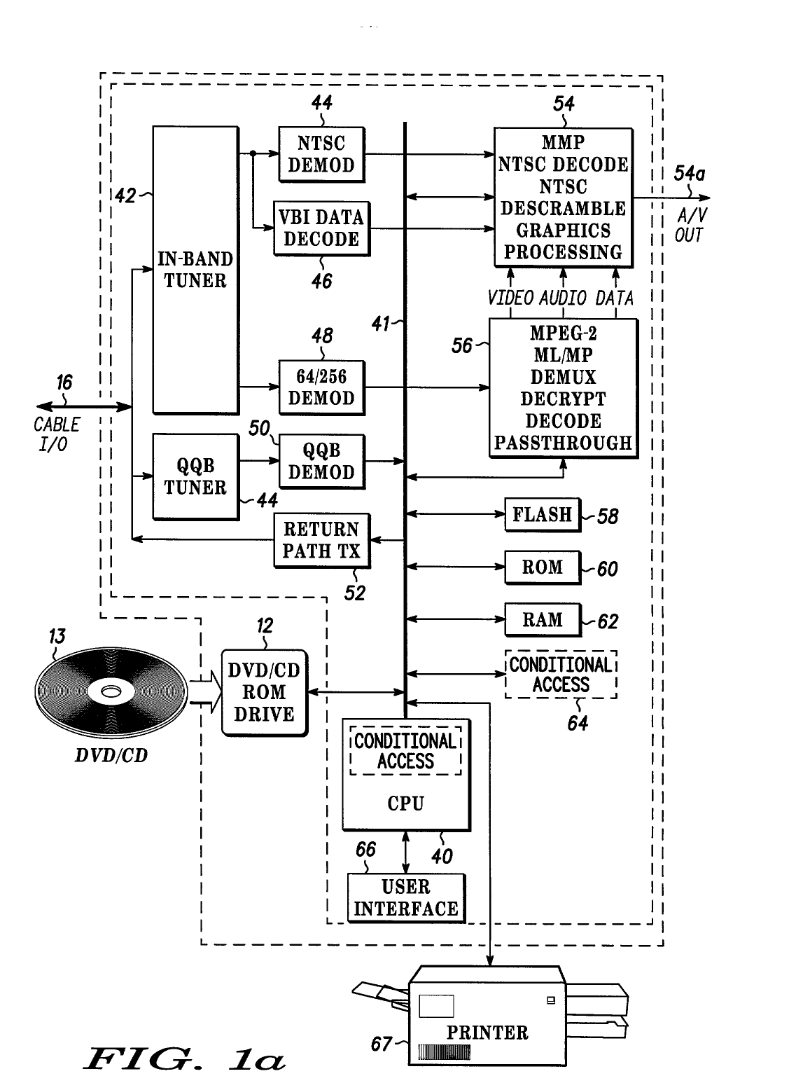

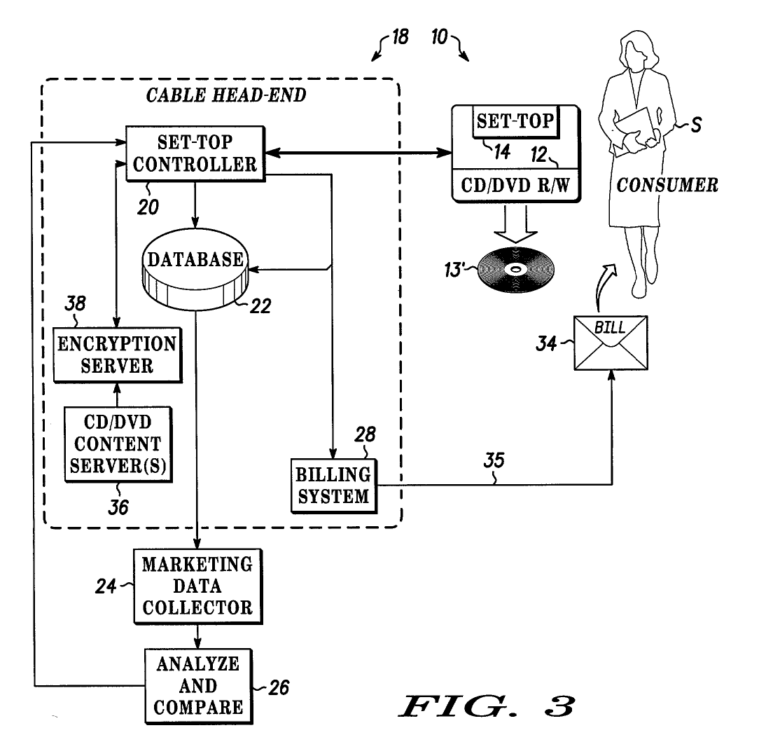

The collected data is transferred from set top 14 by a controller in the head end using standard two-way (RF or Telco) polling methods, as will be further described in connection with FIGS. 2 and 3.

The transfer data may be aggregated by MSO (Multiple System Operator) and utilized to create profiles/usage data that can be sold or licensed to one or more marketing groups.

The subscriber's profile of video/music interests enables the MSO to target the subscriber with specific music/video “suggestions” of other titles in the same genre or by the same artist and can be especially useful in notifying such subscribers of new releases relevant to the subscriber's genre and thereby great another revenue stream through the sales of DVD/CDs. The targeting information can be delivered to set top 14 through the cable in line 16 using either the in-band downstream path or the OOB (Out Of Band) data path.

FIG. 1a shows a more detailed block diagram of MST 10 which is comprised of a CPU 40 functioning as the controller for the MST 10. CPU 40 communicates with the other components of MST 10 primarily by way of data bus 41.

Incoming communications on cable I/O line 16 are selectively passed either by In-Band Tuner 42 or OOB (Out Of Band) tuner 44 to appropriate circuits of MST 10. Communications passed by Tuner 42 undergo demodulation by NTSC Demodulator 44 which applies its output to circuit 54, and/or undergo decoding by VBI Data Decoder 46 which also applies its decoded output to circuit 54, which provides MMP, NTSC decoding, NTSC descrambling and graphics processing, the output of circuit 54 being coupled to conventional audio-visual apparatus by A/V output 54a. 64/256 QAM demodulator 48 couples its output to circuit 56 providing MPEG-2, ML/MP Demux, decrypting and decoding. When receiving an analog channel, data is directed to NTSC Demod 44 and VB1 Data Decod 46. When receiving a digital channel, data is directed to 64/256 QAM Demux 48.

OOB demodulator 50 couples a transmission passed by OOB tuner to bus 41.

A variety of memory devices, such as a FLASH memory 58, ROM 60, RAM 62 and a conditional access port 64, are coupled to data bus 41 for storage and retrieval of data, including the identifying data obtained from CDs/DVDs inserted in drive 12. CPU 40 communicates with the cable head-end through bus 41 and return path transmitter 52.

Data may be manually entered by a subscriber through User Interface 66 which may be a “mouse,” keyboard, remote control or keypad.

FIG. 2 shows a cable system incorporating the capability of the present invention and being comprised of a MST 10 incorporating a DVD/CD player 12 and set top 14 of the type shown in FIG. 1 and shown in greater detail in FIG. 1a. In operation, a Subscriber plays DVDs and/or CDs in player 12. Upon insertion, the CD can be identified using the CDDB database or any other suitable data base which reads a code from the CD/DVD and converts it to title, artist, etc. The MST 10 can record titles, artists, etc. and CD/DVD library identification numbers (such as CDDB) of each CD/DVD played by the subscriber thereby accumulating a history of titles, artists, etc. in the aforementioned non-volatile memory (58 or 62, for example).

An addressable controller 20 in the cable system head-end collects the stored information by polling the set top by way of the two-way cable network 16. The information can be accumulated on a periodic basis and is preferably polled during intervals of reduced traffic demands. Over time, the data is compiled to develop a profile of the subscriber's interests, preferences, etc. The viewer usage data is stored in a user viewership database 22. The profile information can be utilized to create an additional revenue stream by sale or licensing of the profile data to a marketing data collector which may either be a third-party or a specific department of the cable operator. The profile data transferred to marketing/data collector 24 is utilized by apparatus 26 which compares the subscriber databases with a DVD/CD database for the purpose of preparing a customized list of recommendations for each subscriber in the database. This customized list of recommendations is transferred to the addressable set top controller 20 for transmission to the subscriber's MST 10 for display on the A/V receiver (not shown for purposes of simplicity), which presentation may include brief excerpts of suggested CDs and/or DVDs. The addressable controller 20 transmits this information to the subscriber preferably either through the OOB or the in-band downstream paths. The presentation also provides the subscriber with the opportunity to purchase the recommended CDs/DVDs.

The subscriber purchase selections may be inputted through the set top 14, such as for example by a keyboard or “mouse,” remote control or keypad. Purchase selections are recorded by MST 10 and collected by addressable controller 20 using normal polling methods. The adjustable controller 20 provides purchase information to the viewer monitor database 22 and to the billing system 28. The information stored in database 22 enables the MSO to develop a purchase profile in addition to the viewing/listening profile which may generate still another revenue stream.

The billing system transfers the purchase information to an appropriate CD/DVD supplier 30 having suitable sales/warehousing and shipping capabilities. The supplier ships the purchase selections, typically by common carrier 32, to the purchasers residence. The purchase titles are accumulated at the billing system 28 which are added to the subscriber's cable bill sent to the subscriber by mail as shown by dotted line 35. The cable operator has the option of which aspects of the sales/viewer monitoring the cable operator wishes to host and which aspects to contract out to third parties, such as DVD/CD retailers and market data aggregators.

FIG. 3 depicts an alternative embodiment of the present invention in which is shown a similar cable system to that shown in FIG. 2 with the CD/DVD supplier being replaced by a DVD/CD content server 36 and encryption server 38.

The system shown in FIG. 3 operates in substantially the same manner as that shown in FIG. 2 and has the added capability of allowing the subscriber to “buy on demand.” Assuming that the subscriber has agreed to purchase the content suggested by the head-end, the subscriber inserts a blank CD 13′ into the DVD/CD ROM drive 12. Addressable controller 20 authorizes the subscriber for the premium content which is downloaded to MST 10 from content server 36 and encryption server 38 to the set top 14 of the MST 10 through either in-band or OOB transmission. Set top 14 of the MST 10 decrypts the premium content and transfers it to the DVD/CD drive 12 which is provided with a writable DVD drive.

The billing system 28 collects the billing information from the addressable set top controller 20 and incorporates the DVD/CD purchases into the subscriber's normal bill 34, sent to the subscriber typically by mail as shown at 35. This capability enables a subscriber to purchase audio and DVD/CDs without the need for shipping. The subscriber thus has the capability to shop/purchase DVD/CD titles by way of set top 14 and the two-way cable plant. Blank DVDs/CDs can be purchased with conventional, transparent cases. The cable head end 18 transmits graphics and liner notes which can be printed by the optional subscriber's printer 67 (see FIG. 1a) to provide a DVD/CD package substantially identical to those purchased through conventional retail outlets. Alternatively, liner notes may be burned into the CD/DVD which can be inserted into a subscriber's PC (Personal Computer) for printing of the liner notes. Purchase requests are collected by the head end 18 using the aforementioned polling methods and the purchasing information is added to the viewer database to build purchase profiles.

What is claimed is:

1. A method for developing subscriber profiles in a cable system in which a subscriber is provided with a DVD/CD player coupled to a set-top which communicates with a head-end having a controller and a subscriber database, comprising the steps of:
said set top reading data identifying a DVD/CD inserted into the player upon initiation of playback of said DVD/CD;
storing the DVD/CD identifying data;
said set top transferring the DVD/CD identifying data to said controller when polled;
said controller transferring the polled DVD/CD identifying data in the database tegether with the subscriber identifying data which identifies the polled subscriber;
whereby a DVD/CD identifying data accumulated over time develops a stored profile of DVD/CDs played by subscriber;
said subscriber's stored profile being compared by said head-end with a DVD/CD database to develop a suggested list of DVDs/CDs from the DVD/CD database similar to the subscribers profile; and
transferring the suggested list to the subscriber's set-top through said controller for presentation to the subscriber through the set-top.

2. The method of claim 1 further comprising:
said set-top transmitting a request for purchase of a selection entered by the subscriber to said controller;
said controller transferring the purchase request together with the subscriber's identifying data to said database and a billing unit to bill the subscriber for the selected purchase; and
providing the purchase request to a DVD/CD facility to ship the selected purchase to the subscriber.

3. The method of claim 1 wherein said billing unit incorporates a cost of the selected purchase with a bill for other cable services proved to the subscriber.

4. The method of claim 2 wherein the billing unit prints a bill for mailing to the subscriber.

5. The method of claim 1 wherein suggestions transferred to the set-top include a sample of a suggested DVD/CD for play by the subscriber.

6. The method of claim 2 wherein the DVD/CD facility includes a warehouse which picks and packages for shipping, selected purchases to the subscriber according to the subscriber identifying data associated with the selected purchase data.

7. The method of claim 2 wherein a profile of subscriber purchase data is developed in said database as the subscriber engages in purchases through said set-top; and
said subscriber purchase profile being periodically provided to one or more marketing groups for analysis and further targeting activities;

8. The method of claim 2 wherein said DVD/CD drive is a writable type, said method further comprising:
said set-top transmitting a request for purchase of a selection entered by the subscriber from the set-top to said controller;
said controller transferring the purchase request together with the subscribers identifying data to said database and a billing unit which bills the subscriber for the selected purchase; and
said controller transferring to said set-top a encrypted premium content selected by the subscriber;
said selected premium content being decrypted by said set-top and burned into a blank CD inserted into the subscriber's DVD/CD drive responsive to receipt of said selected premium content.

9. The method of claim 8 wherein said encrypted selected premium content is obtained from a content server which provides the selected premium content to an encrypter responsive to a controller request.

10. A cable system comprising:
a head-end having a controller communicating with a subscriber unit providing standard audio-visual service;
said subscriber unit further comprising a set-top communicating with a DVD/CD drive;
a memory for storing DVD/CD identifying data for identifying a DVD/CD entered into the DVD/CD driver by a subscriber when the subscriber activates the drive;
said set-top transferring the stored DVD/CD identifying data to said controller responsive to a controller request;
sais controller storing the DVD/CD identifying data in the head-end database together with subscriber identifying data identifying the subscriber unit transferring the DVD/CD identifying data;
said DVD/CD identifying data serving as a profile of the associated subscriber;
a data analyzer for comparing a subscriber's profile with a DVD/CD database to identify DVD/CD selections in said DVD/CD database which are of a genre/artist related to said subscriber's profile; and
said controller communicating said identified selection to said set-top to present the subscriber with a suggested list of selections which match the subscriber's profile to elicit the subscriber's interest in such selections for possible purchase by the subscriber.

11. The system of claim 10 wherein said set-top communicates a purchase request to said controller responsive to a manual input entered into an input device of the set-top; and
said controller transferring the purchase request to a billing unit for generating a bill for the subscriber making the purchase request.

12. The system of claim 1 0 wherein said set-top communicates a purchase request to said controller responsive to a manual input entered into an input device of the set-top; and
said controller transferring the purchase request to a unit for picking and packing a purchase request for shipment to the subscriber making the purchase request.

13. The system of claim 11 wherein said billing unit incorporates the billing of the selected purchase with the subscriber's bill for other cable services provided to the subscriber.

14. The system of claim 10 wherein said set-top communicates a purchase request to said controller responsive to a manual input entered into an input device of the set-top;
a content server transferring a selected premium content to an encrypter responsive to a purchase request from said controller;
said controller communicating said selected premium content to the subscriber's set-top;
said set-top including a decrypter for decrypting the selected premium content;
said set-top including a writeable CD unit for burning the decrypted selected premium content received from the head-end into a blank CD placed into the writeable CD unit.

15. A method for obtaining DVDs/CDs in a cable system in which a subscriber is provided with a set-top and a DVD/CD player coupled to the set-top which communicates with a head-end having a controller and a subscriber database, comprising the steps of:
said set-top transmitting a request for purchase of a selection entered by the subscriber;
said controller transferring the purchase request together with the subscriber's identifying data to said database and a billing unit to bill the subscriber for the selected purchase; and
providing the purchase request to a DVD/CD facility to ship the selected purchase to the subscriber.

16. The method of claim 15 wherein said billing unit incorporates a cost of the selected purchase with a bill for other cable services proved to the subscriber.

17. The method of claim 16 wherein the billing unit prints a bill for mailing to the subscriber.

18. The method of claim 15 wherein the DVD/CD facility includes a warehouse which picks and packages for shipping, selected purchases to the subscriber according to the subscriber identifying data associated with the selected purchase data.

19. The method of claim 16 wherein said DVD/CD drive is a writable type, said method further comprising:
said set-top transmitting a request for purchase of a selection entered by the subscriber from the set-top to said controller;
said controller transferring the purchase request together with the subscribers identifying data to said database and a billing unit which bills the subscriber for the selected purchase; and
said controller transferring to said set-top an encrypted premium content selected by the subscriber;
said selected premium content being decrypted by said set-top and burned into a blank CD inserted into the subscriber's DVD/CD drive responsive to receipt of said selected premium content.

20. The method of claim 19 wherein the selected premium content transferred by the controller includes transfer of liner notes; and
said selected premium content burned into said CD includes burning in said liner notes.

21. The method of claim 20 further comprising the step of printing liner notes in the CD by insertion of the CD into a personal computer for printing the liner notes.

22. The method of claim 19 wherein said encrypted selected premium content is obtained from a content server which provides the selected premium content to an encrypter responsive to a controller request.

23. A cable system comprising:
a head-end having a controller communicating with a subscriber unit providing standard audio-visual service;
said subscriber unit further comprising a set-top communicating with a DVD/CD drive;
said subscriber unit further comprising a set-top communicating with a DVD/CD drive;
said set-top communicating a purchase request to said controller responsive to a manual input entered into an input device of the set-top; and
said controller transferring the purchase request to a billing unit for generating a bill for the subscriber making the purchase request.

24. The system of claim 23 wherein said set-top communicates a purchase request to said controller responsive to a manual input entered into an input device of the set-top; and
said controller transferring the purchase request to a unit for picking and packing a purchase request for shipment to the subscriber making the purchase request.

25. The system of claim 23 wherein said billing unit incorporates the billing of the selected purchase with the subscriber's bill for other cable services provided to the subscriber.

26. The system of claim 23 wherein said set-top communicates a purchase request to said controller responsive to a manual input entered into an input device of the set-top;
a content server transferring a selected premium content to an encrypter responsive to a purchase request from said controller;
said controller communicating said selected premium content to the subscriber's set-top;
said set-top including a writeable CD unit for burning the decrypted selected premium content received from the head-end into a blank CD placed into the writeable CD unit.

27. The system of claim 26 wherein said content server further includes liner notes associated with the selected premium content; and
said CD unit burns the liner notes into said CD.
